(19) United States
(12) Patent Application Publication
(10) Pub. No.: US 2011/0046433 A1
(43) Pub. Date: Feb. 24, 2011

(54) METHOD AND APPARATUS FOR CONTROLLING TEMPERATURE IN A WARMING THERAPY DEVICE

(75) Inventor: Andrei Khodak, Hatfield, PA (US)

Correspondence Address: IP GROUP OF DLA PIPER LLP (US) - DMI, ONE LIBERTY PLACE, 1650 MARKET STREET, SUITE 4900, PHILADELPHIA, PA, 19103, US

(73) Assignee: DRAEGER MEDICAL SYSTEMS, INC., Telford, PA (US)

(21) Appl. No.: 12/937,035

(22) PCT Filed: Apr. 10, 2009
(86) PCT No.: PCT/US09/40168

§ 371 Date: Oct. 8, 2010

Related U.S. Application Data
(60) Provisional application No. 61/046,972, filed on Apr. 22, 2008.

(51) Int. Cl. A61G 11/00

(52) U.S. Cl. 600/22

(57) ABSTRACT

An apparatus and method for performing warming therapy is described, In one exemplary embodiment, the apparatus includes a patient support assembly and a hood adapted to cover a portion of the patient support assembly, where the hood is comprised of at least one side wall which includes at least one thermoelectric element. The thermoelectric element may be controlled by a current source to effect heating and cooling of a patient disposed on the patient support assembly.

### CROSS REFERENCE TO RELATED APPLICATIONS

This application claims priority to U.S. Provisional Application Ser. No. 61/046,972, filed Apr. 22, 2008, the entire contents of which are incorporated by reference, as if fully set forth herein.

### FIELD OF THE INVENTION

This present invention relates generally to a method and apparatus for performing warming therapy on medical patients. More particularly, the present invention relates to a method and apparatus for controlling temperature in a warming therapy device through the use of heated wall members.

### BACKGROUND OF THE INVENTION

Some conventional warming therapy devices (e.g., incubators, warmers, etc.) include hoods which are used to; (1) prevent an infant patient from falling off a mattress of the warming therapy device, and/or (2) enclose the infant patient, and thus create a ‘closed care’ environment. In a ‘closed care’ setting, the walls of the hood are also used to protect the ‘microenvironment’ around the infant patient, by keeping warm and humid air inside the hood. In a ‘closed care’ setting, the walls of the hood may also participate in maintaining a thermal balance of the infant patient. Often times, a separate convective heater is used in ‘closed care’ treatment, which creates heated air inside the hood.

However, conventional warming therapy devices have the following limitations: (1) controlled warming therapy of the infant patient cannot be provided by the walls of the hood alone, thus a separate source of heat is often required (e.g., infrared heater, convective heater), (2) controlled body cooling of the infant patient cannot be provided by the walls of the hood, (3) convective heaters with resistive heating elements consume electric energy in an amount equal to the heat energy provided, and thus, a significant amount of electric energy is needed to provide effective warming therapy, leading to large battery sizes to allow adequate performance during transport, and (4) the exterior sides of the hood walls are almost always colder than air inside the hood, which leads to condensation on the walls, which in turn leads to elevated water and power consumption by the humidifier of the incubator, which can create additional problems during transport (e.g, often a special drainage system is required to gather the condensation).

Accordingly, there is presently a need for a warming therapy device that improves heating and cooling of a patient, while simultaneously reducing power consumption. There is also presently a need for a warming therapy device that reduces or eliminates condensation on the walls of a hood covering the patient.

### SUMMARY OF THE INVENTION

An exemplary embodiment of the present invention comprises an apparatus including a patient support assembly and a hood adapted to cover a portion of the patient support assembly, wherein the hood is comprised of at least one side wall, the at least one side wall including at least one thermoelectric element.

An exemplary embodiment of the present invention also comprises a hood for a warming therapy device adapted to cover a portion of a patient support assembly, the hood including at least four side walls and at least one top portion which is separable from the at least four side walls, wherein at least one of the at least four side walls includes at least one thermoelectric element.

An exemplary embodiment of the present invention also comprises a wall for use with a patient support assembly, said wall including a first layer, a second layer and a thermoelectric element disposed between the first and second layers.

An exemplary embodiment of the present invention also comprises an apparatus including a patient support assembly and a hood adapted to cover a portion of the patient support assembly, wherein the hood is comprised of at least one side wall, the at least one side wall including at least one infrared radiation source and at least one mirror.

An exemplary embodiment of the present invention also comprises a method of providing warming or cooling therapy to a patient disposed on a patient support assembly, the method including the steps of providing a thermoelectric element adjacent a patient, supplying current of a first polarity to the thermoelectric element to effect heating of the patient, and supplying current of a second opposing polarity to the thermoelectric element to effect cooling of the patient.

An exemplary embodiment of the present invention also comprises a method of providing warming therapy to a patient, disposed on a patient support assembly, the method including the steps of providing a linear radiation source within at least one side wall of a hood which covers a portion of the patient support assembly, said side wall being adjacent the patient and activating the linear radiation source to effect heating of the patient.

An exemplary embodiment of the present invention also comprises an apparatus including a patient support assembly and a hood adapted to cover a portion of the patient support assembly, wherein the hood is comprised of at least one side wall, the at least one side wall including at least one waveguide formed therein.

### BRIEF DESCRIPTION OF THE DRAWINGS

FIG. 1 is perspective view of a warming therapy device according to a first exemplary embodiment of the present invention.

FIG. 2 is an overhead perspective view of the warming therapy device of FIG. 1.

FIG. 3 is a simplified overhead perspective view of the patient support assembly and mattress tray assembly of the warming therapy device shown in FIGS. 1 and 2.

FIG. 4 shows a side cross-sectional view of one of the side walls of the warming therapy device according to the first exemplary embodiment of the present invention.

FIG. 5 shows a side cross-sectional view of the mattress (with an infant patient disposed thereon), and one of the side walls of the warming therapy device according to the first exemplary embodiment of the present invention, in a heating mode.

FIG. 6 shows a side cross-sectional view of the mattress (with an infant patient disposed thereon), and one of the side walls of the waning therapy device according to the first exemplary embodiment of the present invention, in a cooling mode.

FIG. 7 shows a front view of one of the side walls of the warming therapy device according to a first exemplary embodiment of the present invention.

FIG. 8 shows a side cross-sectional view of a side wall according to a second exemplary embodiment of the present invention.

FIG. 9 shows a front view of the side wall shown in FIG. 8.

FIG. 10 shows a side cross-sectional view of a side wall according to a third exemplary embodiment of the present invention.

FIG. 11 shows a side cross-sectional view of a side wall according to a fourth exemplary embodiment of the present invention.

FIG. 12 shows a side cross-sectional view of a side wall according to a fifth exemplary embodiment of the present invention.

FIG. 13 shows a side cross-sectional view of a mattress (with an infant patient disposed thereon), and one of the side walls of a warming therapy device according to the third exemplary embodiment of the present invention.

### DETAILED DESCRIPTION

The present invention relates to a warming therapy device (e.g., incubator, warmer, etc.) including a hood with heated side walls. In one exemplary embodiment, the warming therapy device includes at least one wall comprised of at least two transparent or translucent layers, wherein one of the layers is coupled to one or more thermally conductive metal plates. In another exemplary embodiment, one of the thermally conductive metal plates includes a metal plate and metal rods for improving heat transfer. In yet another exemplary embodiment, the at least two transparent or translucent layers form a waveguide through which infrared (IR) radiation may transmitted. In another exemplary embodiment, the wall of the warming therapy device may be formed from a single transparent or translucent member, which forms a waveguide through which IR radiation may be transmitted. In yet another exemplary embodiment, the wall of the warming therapy device may be formed from a flexible single transparent or translucent member, which forms a waveguide through which IR radiation may be transmitted.

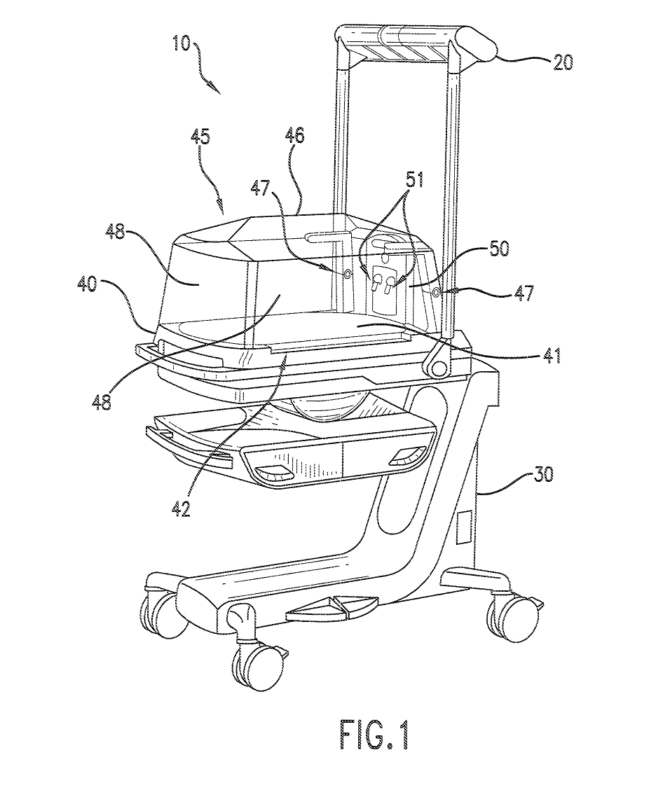

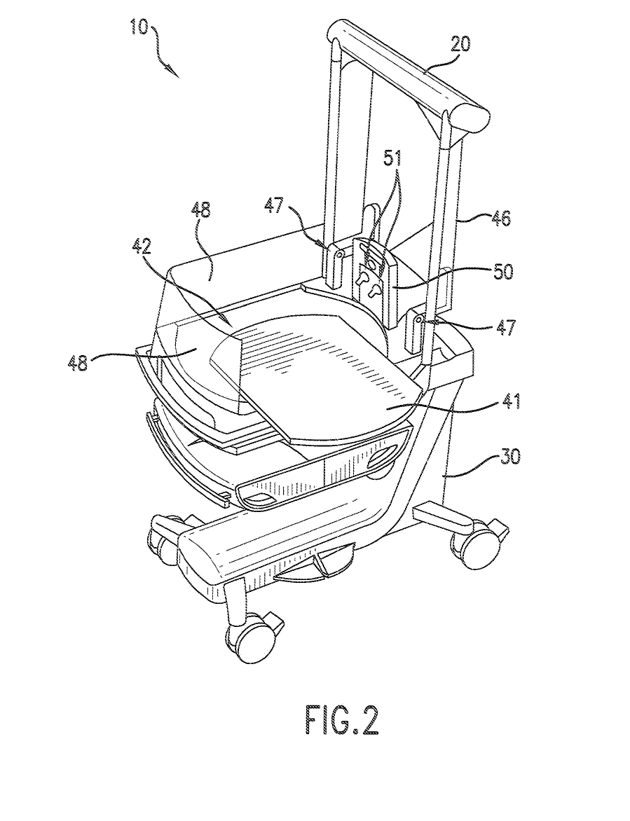

FIGS. 1 and 2 show a warming therapy device 10 according to a first exemplary embodiment of the present invention. The warming therapy device 10 includes a radiant heater head 20, a patient support assembly 30, and a mattress tray assembly 40. The mattress tray assembly 40 may include a hood 45 which has a top portion 46 which pivots about one or more axes 47. The hood 45 may also include one or more side walls 48 which may be slideable, removable, pivotable or rotatable. The mattress tray assembly 40 may also include a mattress tray 41 (containing a mattress) disposed within a recessed support base 42.

The mattress tray 41 may be made rotatable within the support base 42 up to three hundred and sixty degrees (360°). FIG. 2 specifically shows the mattress tray 41, rotated approximately ninety degrees (90°) with respect to the position shown in FIG. 1. FIG. 2 also shows the top portion 46 of the hood 45 rotated up so that it is approximately ninety degrees (90°) with respect to the mattress tray 41. In the exemplary embodiment shown in FIG. 2, the side walls 48 of the hood 45 are capable of sliding vertically within a portion of the mattress tray assembly 40, so that they may become disposed, partially or completely, below the plane of the mattress tray 41.

The warming therapy device 10 may optionally include a backplane 50, to which ventilation hoses and other devices may be coupled through, for example, interconnection nozzles 51. For example, the backbone may include one or more of (1) nozzles of various sizes and configurations for attaching hoses and lines for medical treatment (e.g., ventilation hoses), (2) a camera, (3) examination lights, and (4) bilirubin treatment lights (i.e., lights designed to reduce bilirubin levels in infants, as are known in the art).

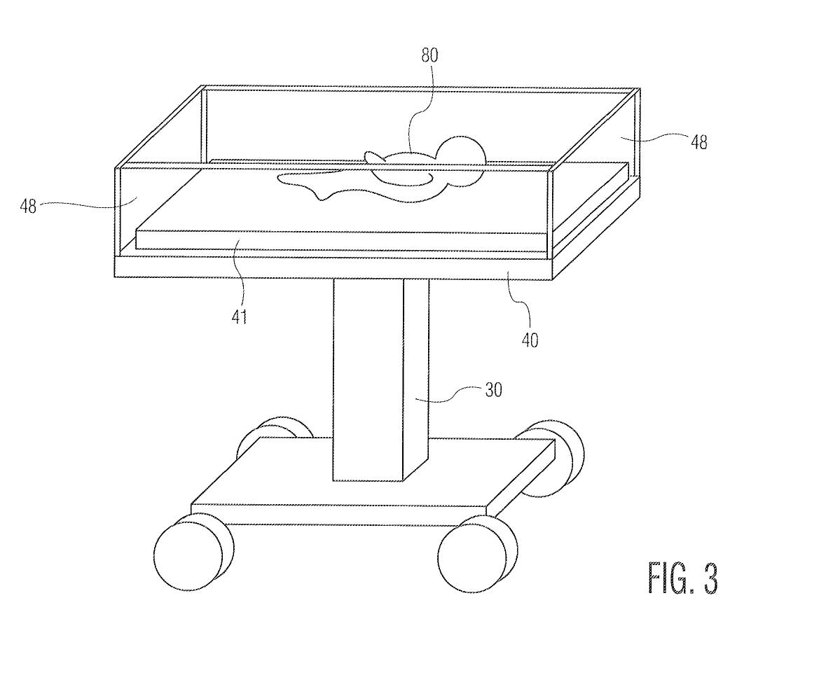

FIG. 3 shows a simplified overhead perspective view of the warming therapy device 10 shown in FIGS. 1 and 2. As shown, an infant patient 80 may be disposed on a mattress (not numbered) of the mattress tray 41, and confined by the side walls 48. One or more of the side walls 48 may be configured to provide heating, and cooling, to the infant patient 80, as described in detail below.

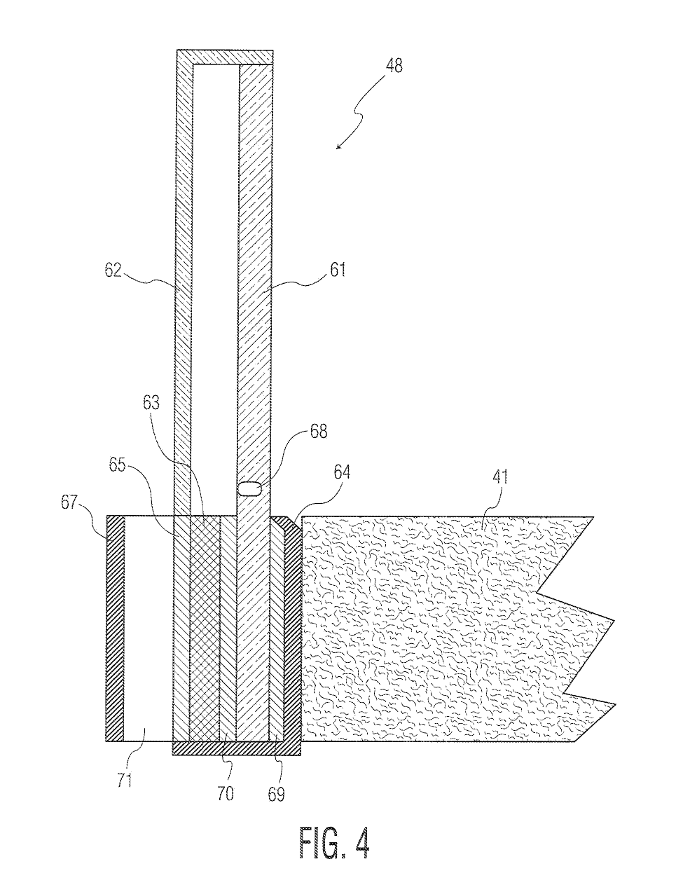

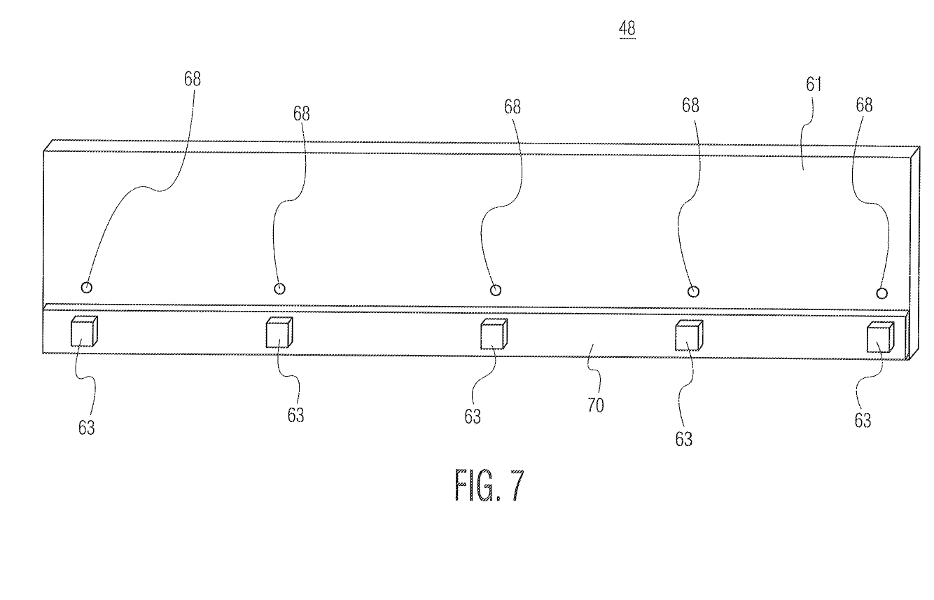

FIG. 4 shows a side cross-sectional view of one of the side walls 48 of the warming therapy device 10 according to the first exemplary embodiment of the present invention. The side wall 48 may be comprised of two (2) transparent or translucent layers 61, 62 separated by an air gap for thermal insulation. The inner layer 61 faces the mattress of the mattress tray 41 (on which an infant patient may be disposed), and is involved in heat exchange. The outer layer 62 is spaced apart from the inner layer 61 by an air gap, and may be used to enhance thermal insulation from the outside environment. Inner layer 61 may be attached to a thermoelectric element 63 either directly, or through thermally conductive metal plates 69 and 70. The thermoelectric element 63 may comprise a single element, or a plurality of elements (as shown in FIG. 7). For ease of reference, the thermoelectric element 63 will be referred to herein in the singular, even though such structure may be comprised of plural elements. The thermoelectric element 63 utilizes the Peltier effect, essentially using electric energy to create a temperature difference between the two faces of the thermoelectric element. The cold and hot sides of the thermoelectric element 63 can be changed by changing the polarity of the direct current supplied to the thermoelectric element. Thus, each side of the thermoelectric element 63 can act as a heater or a cooler, depending on the direction of electric current.

The side wall 48 may also include an insulator 64 which minimizes the leakage of heat from the inner wall 61 and thermoelectric element 63. The face of the thermoelectric element 63 opposite to the inner layer 61 may be thermally coupled to a metal plate 65 with fins 71, which acts as a source or sink of heat, depending cm whether warming or cooling therapy is being provided. The tips of the fins 71 may be covered by protective wall 67, leaving openings on the side of the fins for air passage. A temperature probe 68 may also be provided in the area around the side wall 48 for thermal control. In the exemplary embodiment shown in FIG. 4, the temperature probe 68 is coupled to the inner wall 61, but those of ordinary skill in the art will realize that the temperature probe may be disposed in various positions in and around the side wall 48 in order to accurately sense temperature changes.

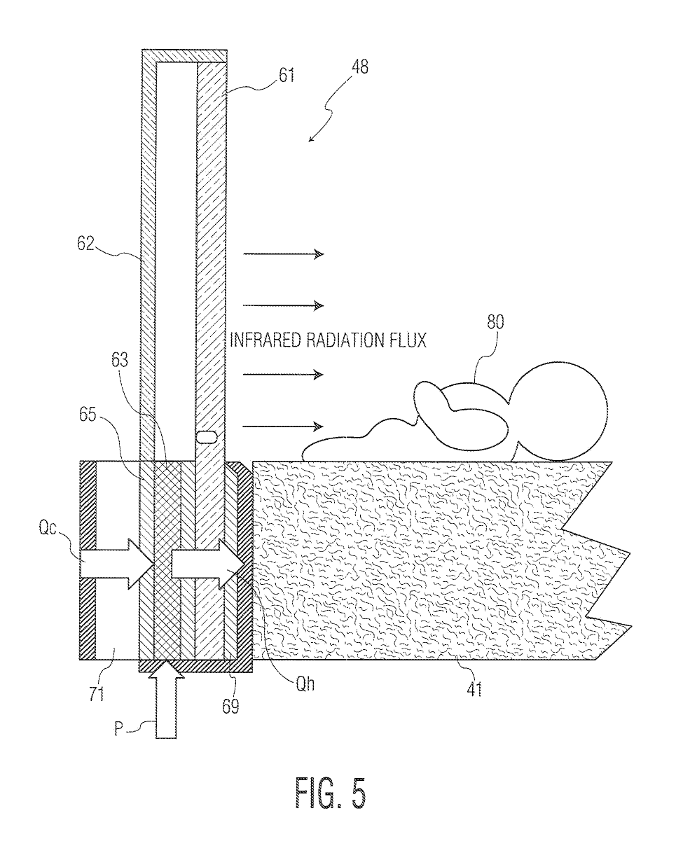

FIG. 5 shows a side cross-sectional view of the mattress and mattress tray 41 (with an infant patient 80 placed thereon), and one of the side walls 48 according to the first exemplary embodiment of the present invention. Specifically, FIG. 5 shows the operation of the side wall 48 in a ‘warming’ mode. In this mode, the temperature of the inner side of the thermoelectric element 63 (i.e., the side facing the inner layer 61) is made higher than the outer side (i.e., the side facing the outer layer 62). In this configuration, the inner layer 61 of the side wall 48 acts as a heat sink. As the temperature of the inner layer 61 increases, infrared radiant heating of the infant patient 80 may be achieved. Particularly, the thermoelectric element 63 heats the side wall 48, which in turn, transmits radiant heat to the patient. The heating of inner layer 61 also heats the air surrounding the infant patient 80, thus providing additional warming, especially in a ‘closed care’ environment (e.g., where the top portion 46 of the hood 45 is disposed over the infant patient 80). Increasing the temperature of the inner layer 61 above the dew point will also eliminate condensation on the side wall 48. This, in turn, allows the warming therapy device to be operated at high humidity levels without ‘rainout’ (i.e., the formation of dripping condensation on the inner side of the hood 45). Thus, the visibility of the infant patient 80 through the side walls 48 of the hood 45 will be improved, and contamination risk due to water droplets will be reduced or eliminated.

When the thermoelectric element 63 is used in the manner described above to heat the side wall 48, it uses not only electric power (provided by electric power line P in FIG. 5), but also heat flux Qc from the air surrounding the warming therapy device 10 to heat the infant patient 80. Particularly, the reference “Qc” stands for the heat flux on the cold side of the thermoelectric element 63, and “Qh” stands for the heat flux on the hot side of the thermoelectric element. Because of the additional heating energy provided by heat flux Qc, electric power consumption during warming therapy may be significantly reduced compared to conventional warming therapy devices which rely almost exclusively on resistive or convective heating elements which are powered solely by electricity.

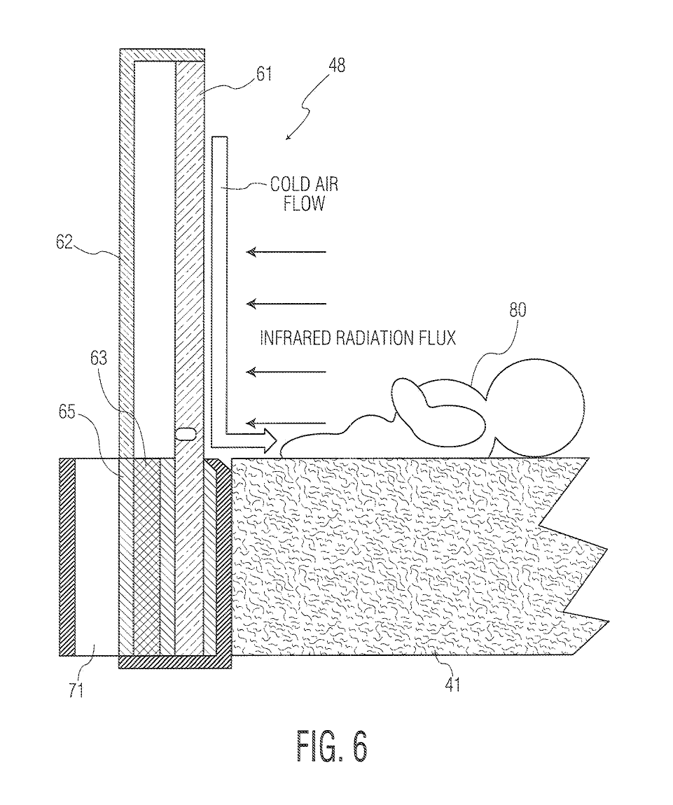

FIG. 6 shows a side cross-sectional view of the mattress and mattress tray 41 (with an infant patient 80 disposed thereon), and one of the side walls 48 according to the first exemplary embodiment of the present invention. Specifically, FIG. 6 shows the operation of the side wall 48 in a ‘cooling’ mode. In this mode, the thermoelectric element 63 operates with reversed polarity, such that the temperature of the inner side of the thermoelectric element (i.e., the side facing the inner layer 61) is lower than the temperature of the outer side (i.e., the side facing the outer layer 62), resulting in heating of the inner layer 61. The inner layer 61 thus acts as a heat source, and its temperature decreases. Thus, active cooling of the infant patient 80 ran be achieved. This cooling may be achieved by means of infrared radiation heat transfer from the infant patient 80 to the cold inner layer 61 of the side wall 48. Particularly, the thermoelectric element 63 cools the side wall 48, which in turn, draws radiant heat away from the infant patient 80. Additionally, the air near the inner layer 61 will be cooled and will naturally flow towards the infant patient providing additional convective cooling. In this case, heat is transferred from the infant patient to the inner layer 61, and then through thermoelectric element 63 to heat sink 65, where it is released into the environment.

FIG. 7 shows a front view of the side wall 48 of an warming therapy device 10 according to the first exemplary embodiment of the present invention. As shown, a first thermally conductive metal plate 70 may be coupled directly to a first side of the inner layer 61, and the thermoelectric element 63 (which may be comprised of plural elements in the exemplary embodiment) may be coupled directly to the conductive metal plate 70. As noted above, a second thermally conductive metal plate 69 may be coupled directly to a second side of the inner layer 61, however for ease of reference this plate is not shown in FIG. 7. Either of the first or second thermally conductive metal plates 69, 70 may be coupled to thermoelectric element(s) using thermally conductive fasteners (not shown). Thermally conductive metal plates 69, 70 can be used to smooth the heating or cooling action of the thermoelectric element(s) 63 along the inner layer 61, and thus intensify the heat transfer process. As noted above, one or more temperature probes 68 may also be provided for thermal control.

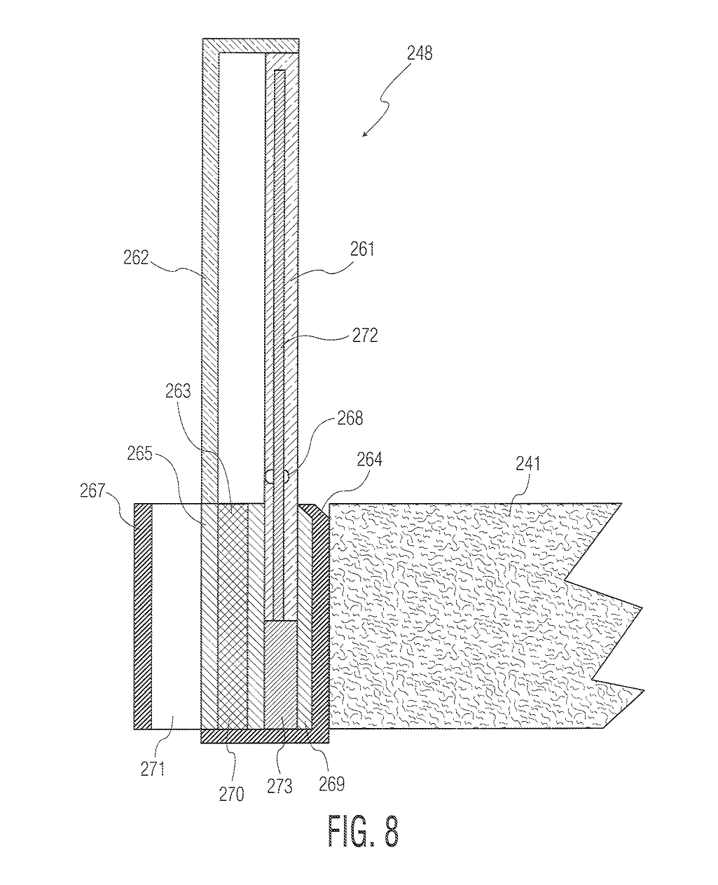

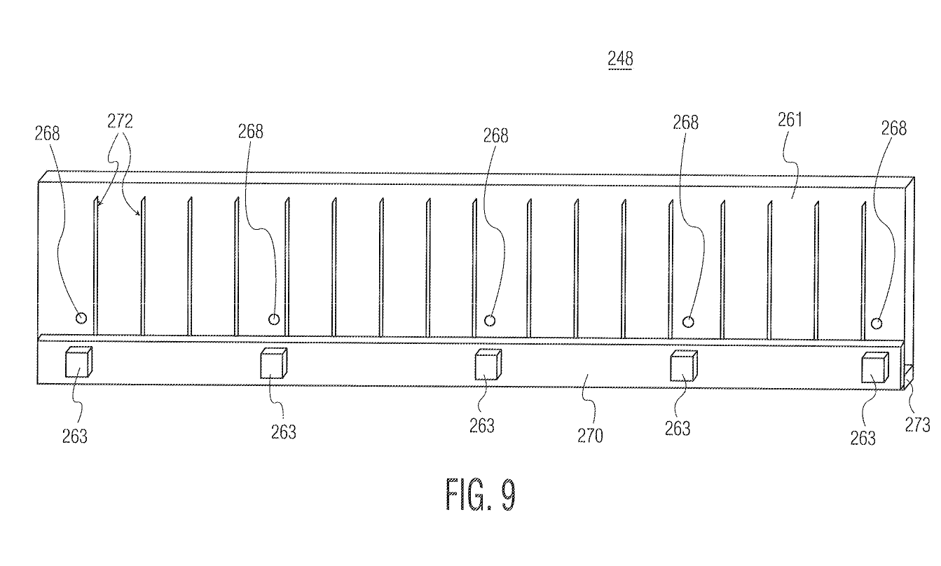

FIG. 8 shows a side cross-sectional view of a side wall 248 of an warming therapy device according to a second exemplary embodiment of the present invention. The side wall 248 may be comprised of two (2) transparent or translucent layers 261, 262 separated by an air gap for thermal insulation. The inner layer 261 faces the mattress of the mattress tray 241 (on which an infant patient may be disposed), and is involved in heat exchange. The outer layer 262 is spaced apart from the inner layer 261 by an air gap, and may be used to enhance thermal insulation from the outside environment. Inner layer 261 may be attached to a thermoelectric element 263 either directly, or through thermally conductive metal plates 269 and 270. The thermoelectric element 263 may comprise a single element, or a plurality of elements (as shown in FIGS. 7 and 9). For ease of reference, the thermoelectric element 263 will be referred to herein in the singular, even though such structure may be comprised of plural elements. The thermoelectric element 263 utilizes the Peltier effect, essentially using electric energy to create a temperature difference between the two faces of the thermoelectric element. The cold and hot sides of the thermoelectric element 263 can be changed by changing the polarity of the direct current supplied to the thermoelectric element. Thus, each side of the thermoelectric element 263 can act as a heater or a cooler, depending on the direction of electric current.

The side wall 248 may also include an insulator 264 which minimizes the leakage of heat from the inner wall 261 and thermoelectric element 263. The face of the thermoelectric element 263 opposite to the inner layer 261 may be thermally coupled to a metal plate 265 with fins 271, which acts as a source or sink of heat, depending on whether warming or cooling therapy is being provided. The tips of the fins 271 may be covered by a protective wall 267, leaving openings on the side of the fins for air passage. A temperature probe 268 may also be provided for thermal control.

Alternatively from the first exemplary embodiment described above, thin metal rods 272 may be implanted into the inner layer 261 of the side wall 248 according to the second exemplary embodiment, to further intensify heat transfer (see FIG. 9). Heat transfer to the metal rods 272 may additionally be intensified by a metal plate 273 coupled to the metal rods and the thermally conductive metal plates 269 and 270. Those of ordinary skill in the art will understand that the side wall 248 may be utilized in connection with an warming therapy device according to a second exemplary embodiment of the present invention which is substantially similar to the warming therapy device 10 shown and described above with reference to FIGS. 1-7, but which includes the side wall 248 in place of the side wall 48.

FIG. 9 shows a front view of the side wall 248 according to the second exemplary embodiment of the present invention. As will be noted, the metal rods 272 are distributed roughly evenly along the length of the inner wall 261, and coupled to the metal plate 273. The side wall 248 operates in roughly the same manner as the side wall 48 described above to effect heating and cooling of an infant patient, and therefore a detailed description will not be repeated here.

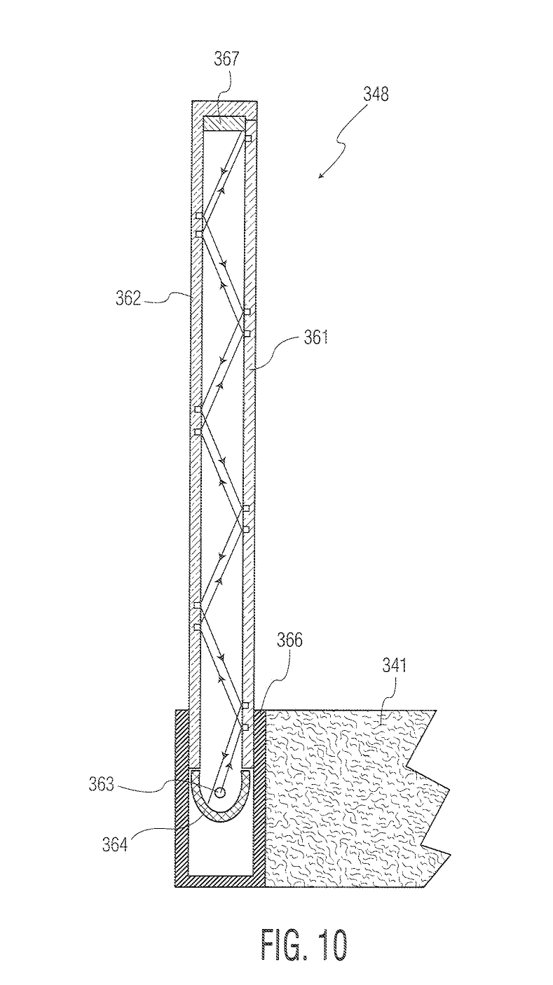

FIG. 10 shows a side cross-sectional view of a side wall 348 according to a third exemplary embodiment of the present invention. The side wall 348 may be comprised of two (2) transparent or translucent layers 351, 362 which form a waveguide through which infrared (IR) radiation may transmitted. The inner layer 361 faces the mattress of the mattress tray 341 (on which an infant patient may be disposed), and is involved in heat exchange. The outer layer 362 is spaced apart from the inner layer 261 by an air gap, and may be used to enhance thermal insulation from the outside environment.

The IR radiation may be generated by a linear radiation source 363, and focused by a reflector 364. An insulator layer 366 is used to reduce leakage of heat from the linear radiation source 363. Particularly, the insulator layer 366 separates the layer 362 and the linear radiation source 363 from the mattress and mattress tray 341 (on which the infant patient may be disposed). The side wall 348 may also include a mirror 367 for re-directing IR radiation back into the waveguide formed by the layers 361, 362. The IR radiation generated by the linear radiation source 363 is transmitted through the air gap between the layers 361, 362, and accordingly experiences only minimal absorption loss. However, after multiple reflections of the IR radiation off the layers 361 and 362, the radiation is ultimately absorbed by the layers, thus increasing the temperature of the layers. Those of ordinary skill in the art will understand that the side wall 348 may be utilized in connection with an warming therapy device according to a third exemplary embodiment of the present invention which is substantially similar to the warming therapy device 10 shown and described above with reference to FIGS. 1-7, but which includes the side wall 348 in place of the side wall 48.

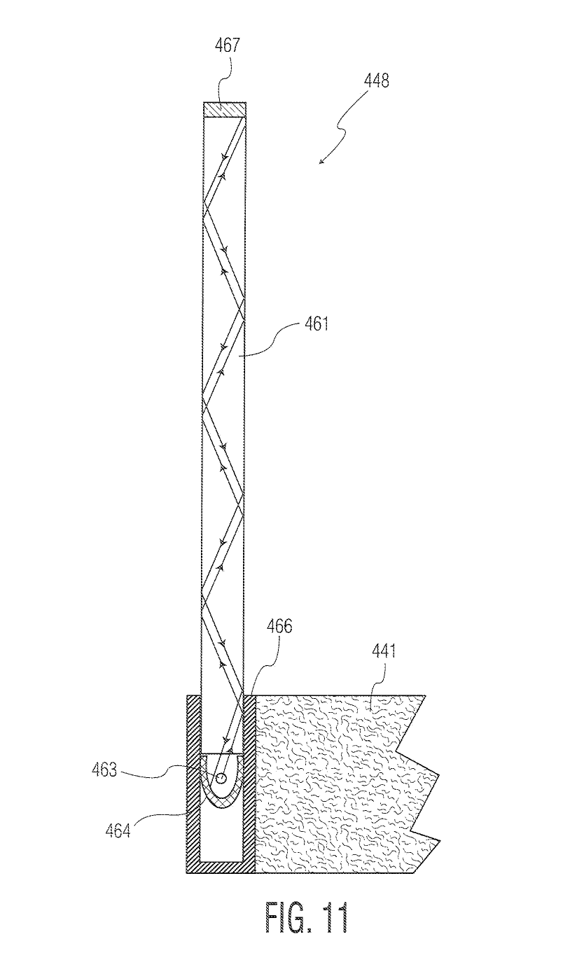

FIG. 11 shows a side cross-sectional view of a side wall 448 according to a fourth exemplary embodiment of the present invention. The side wall 448 may be comprised of one (1) substantially solid transparent or translucent member 461 which forms a waveguide through which infrared (IR) radiation may transmitted. The member 461 has a side which faces the mattress of the mattress tray 441 (on which an infant patient may be disposed). The IR radiation may be generated by a linear radiation source 463, and focused by a reflector 464. An insulator layer 466 is used to reduce leakage of heat from the linear radiation source 463. Particularly, the insulator layer 466 separates the member 461 and the linear radiation source 463 from the mattress and mattress tray 441 (on which the infant patient may be disposed). The side wall 448 may also include a mirror 467 for re-directing IR radiation back into the waveguide formed by the member 461. In the fourth exemplary embodiment, the IR radiation is absorbed by the member 461 during propagation (as opposed to after multiple reflections, as described in connection with the third exemplary embodiment). Absorbed radiation is transformed into heat, and thus the temperature of the member 461 is increased. Those of ordinary skill in the art will understand that the side wall 448 may be utilized in connection with an warming therapy device according to a fourth exemplary embodiment of the present invention which is substantially similar to the warming therapy device 10 shown and described above with reference to FIGS. 1-7, but which includes the side wall 448 in place of the side wall 48.

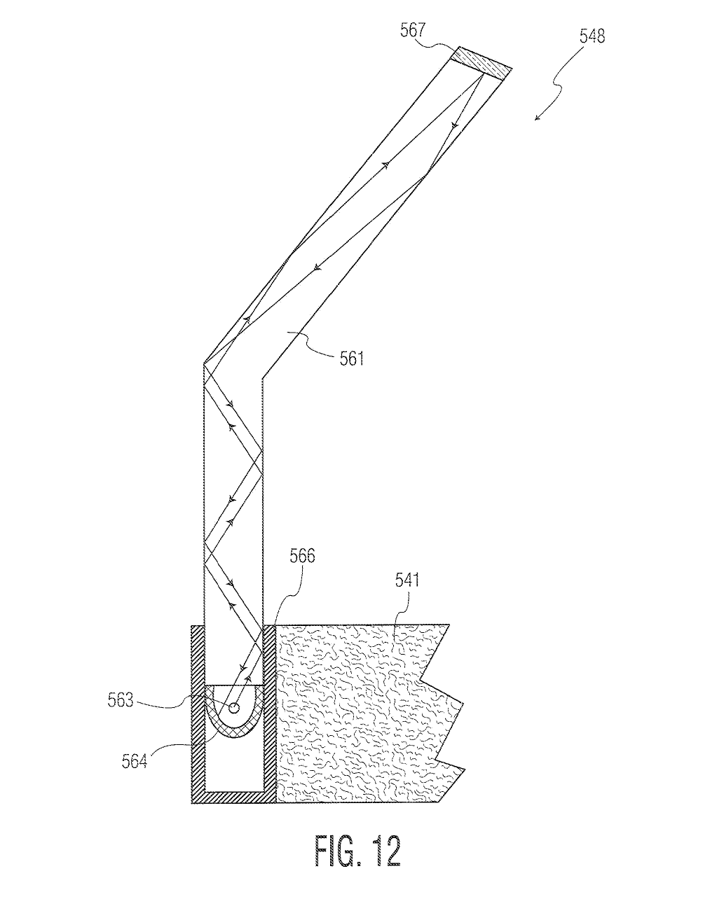

FIG. 12 shows a side cross-sectional view of a side wall 548 according to a fifth exemplary embodiment of the present invention. The side wall 548 is substantially similar to the side wall 448, except that it includes a flexible substantially solid transparent or translucent member 561 which forms a waveguide through which infrared (IR) radiation may transmitted. The flexible member 561 may be bent or angled as shown in FIG. 12 in a direction towards (or away from) an infant patient disposed on the mattress and mattress tray 541. The flexible member 561 has a side which faces the mattress of the mattress tray 541 (on which an infant patient may be disposed). The flexible member 561 may be semi-permanently bent or angled as shown in FIG. 12 in a direction towards (or away from) an infant patient disposed on the mattress and mattress tray 541. Those of ordinary skill in the art will realize that bending the flexible member 561 towards the mattress tray 541 increases heating of the infant patient situated thereon, and bending the flexible member 561 away from the mattress tray 541 decreases heating of the infant patient. The IR radiation may be generated by a linear radiation source 563, and focused by a reflector 564. An insulator layer 566 may be used to reduce leakage of heat from the linear radiation source 563. Particularly, the insulator layer 566 separates the flexible member 561 and the linear radiation source 563 from the mattress tray 541 (on which the infant patient may be disposed). The side wall 548 may also include a minor 567 for re-directing IR radiation back into the waveguide formed by the member 561. In the fifth exemplary embodiment, the IR radiation is absorbed by the member 561 during propagation (as opposed to after multiple reflections, as described in connection with the third exemplary embodiment). Absorbed radiation is transformed into heat, and thus the temperature of the member 561 is increased. Those of ordinary skill in the art will understand that the side wall 548 may be utilized in connection with an warming therapy device according to a fifth exemplary embodiment of the present invention which is substantially similar to the warming therapy device 10 shown and described above with reference to FIGS. 1-7, but which includes the side wall 548 in place of the side wall 48.

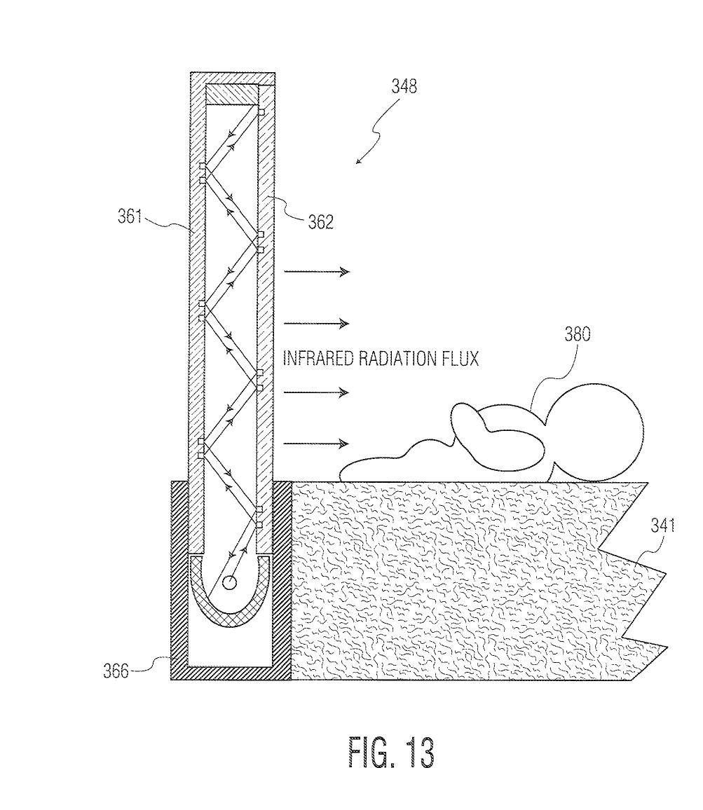

FIG. 13 shows a side cross-sectional view of the mattress and mattress tray 341 (with an infant patient 380 disposed thereon), and one of the side walls 348 according to the above-described third exemplary embodiment of the present invention. FIG. 13 shows the flow of air in a ‘warming’ mode. In this mode, the temperature of the inner layer 361 is increased by the reflections of IR radiation within the waveguide formed by layers 361, 362, as described above. As the temperature of the inner layer 361 is increased, heating through IR radiation of the infant patient 380 is also achieved. Because the heating of the inner layer 361 (and of the side wall 348 itself) also heats the air surrounding the patient, additional warming may be provided (in addition to the IR radiation warming), especially in ‘closed care’ environment (e.g., where a top portion of the hood is disposed over the infant patient 380). Increasing the temperature of the inner layer 361 above the dew point will eliminate the condensation on the side wall 348. This, in turn, allows the warming therapy device to be operated at high humidity level without ‘rainout’ (i.e., the formation of dripping condensation on the inner side of the hood). Thus, the visibility of the infant patient 380 through the side walls 348 of the hood will be improved, and contamination risk due to water droplets will be reduced or eliminated.

Although the side wall 548 according to the fifth exemplary embodiment is the only exemplary embodiment discussed above which includes a flexible side wall, those of ordinary skill in the art will realize that any of the first through fourth exemplary embodiments described above may include a flexible side wall.

Although exemplary embodiments of the present invention have been described above for use in procedures involving infant patients, those of ordinary skill in the art will realize that the warming therapy device 10, and the various side walls 48, 248, 348, 448 and 548 according to the exemplary embodiments of the present invention, may be used for other types of operations and procedures, including for children and adults.

Further, although the descriptions of the side walls 48, 248, 348, 448 and 548 according to the exemplary embodiments of the present invention primarily discuss a single side wall with heating and cooling features, those of ordinary skill in the art will realize that warming therapy devices according to the present invention may include multiple side walls with the heating and cooling structure described above. For example, a hood with four (4) side walls manufactured according to the one of the exemplary embodiments is within the scope of the present invention.

Additionally, although the side walls 48, 248, 348, 448 and 548 according to the exemplary embodiments of the present invention are described above as being transparent or translucent (or including transparent or translucent portions), those of ordinary skill in the art will realize that such is not a necessary feature of the present invention. Such side walls, or portions thereof, may be made such that they are not transparent or translucent, so long as other side walls are transparent or translucent, so that the patient inside the hood may be viewed from the outside. For example, where a hood surrounding a patient has four (4) side walls, one or more of such side walls may be made according to one of the exemplary embodiments of the present invention, but also non-transparent/translucent, and one or more of the other side walls may be made transparent or translucent. Those of ordinary skill in the art will realize that in such a structure, at least one of the side walls should be made transparent or translucent, so that the patient may be viewed from the outside.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

What is claimed is:

1. An apparatus comprising:
a patient support assembly; and,
a hood adapted to cover a portion of the patient support assembly, wherein the hood is comprised of at least one side wall, said at least one side wall including at least one thermoelectric element.

2. The apparatus of claim 1, wherein the hood is comprised at least four side walls, wherein at least one of the at least four side walls includes at least one thermoelectric element.

3. The apparatus of claim 1, wherein the at least one side wall further comprises a first layer and a second layer, such that the at least one thermoelectric element is disposed between the first and second layers.

4. The apparatus of claim 1, wherein the at least one side wall further comprises a metal plate including one or more fins, said metal plate coupled to the thermoelectric element.

5. The apparatus of claim 4, further comprising a protective wall coupled to at least one of the one or more fins.

6. The apparatus of claim 3, wherein the at least one side wall further comprises a first conductive layer disposed on a first side of the first layer and a second conductive layer disposed on a second opposing side of the first layer.

7. The apparatus of claim 6, wherein the at least one side wall further comprises an insulator coupled to at least one of the first and second conductive layers.

8. The apparatus of claim 1, further comprising a mattress tray assembly for supporting a patient thereon, said mattress tray assembly coupled to the patient support assembly.

9. The apparatus of claim 8, wherein the mattress tray assembly is disposed adjacent the first layer of the at least one side wall.

10. The apparatus of claim 1, wherein the at least one side wall further rises one or more temperature probes.

11. The apparatus of claim 3, wherein the at least one side wall further comprises at least one metal rod disposed within the first layer of the at least one side wall.

12. The apparatus of claim 11, wherein the at least one side wall further comprises a metal plate coupled to the at least one metal rod.

13. A hood for a warming therapy device adapted to cover a portion of a patient support assembly, the hood comprising:
at least four side walls; and
at least one top portion which is separable from the at least four side walls, wherein at least one of the at least four side walls includes at least one thermoelectric element.

14. The hood of claim 13, wherein the at least one side wall further comprises a first layer and a second layer, such that the at least one thermoelectric element is disposed between the first and second layers.

15. A wall for use with a patient support assembly, said wall comprising:
a first layer;
a second layer; and,
a thermoelectric element disposed between the first and second layers.

16. The wall of claim 15, further comprising:
a first conductive layer disposed on a first side of the first layer; and,
a second conductive layer disposed on a second opposing side of the first layer.

17. The wall of claim 16, further comprising:
an insulator coupled to at least the first conductive layer; and
a metal plate including one or more fins coupled to the thermoelectric element.

18. An apparatus comprising:
a patient support assembly; and,
a hood adapted to cover a portion of the patient support assembly, wherein the hood is comprised of at least one side wall, said at least one side wall including at least one infrared radiation source and at least one mirror.

19. The apparatus of claim 18, wherein the hood is comprised at least four side walls, wherein at least one of the at least four side walls includes at least one infrared radiation source and at least one reflector.

20. The apparatus of claim 18, wherein the at least one side wall is formed of a first layer and a second layer which are separated by an air gap.

21. The apparatus of claim 18, wherein the at least one infrared radiation source and the at least one reflector are disposed within the air gap.

22. The apparatus of claim 18, further comprising an insulating layer coupled to the at least one side wall.

23. The apparatus of claim 18, wherein the at least one side wall is flexible.

24. A method of providing warming or cooling therapy to a patient disposed on a patient support assembly, the method comprising the steps of:
providing a thermoelectric element adjacent a patient;
supplying current of a first polarity to the thermoelectric element to effect heating of the patient; and
supplying current of a second opposing polarity to the thermoelectric element to effect cooling of the patient.

25. The method of claim 24, wherein the thermoelectric element is coupled to at least one side wall of a hood substantially surrounding the patient.

26. A method of providing warming therapy to a patient disposed on a patient support assembly, the method comprising the steps of:
providing a linear radiation source within at least one side wall of a hood which covers a portion of the patient support assembly, said side wall being adjacent the patient; and,
activating the linear radiation source to effect heating of the patient.

27. The method of claim 26, wherein the at least one side wall further includes at least one reflector disposed therein for reflecting light from the linear radiation source.

28. An apparatus comprising:
a patient support assembly; and,
a hood adapted to cover a portion of the patient support assembly, wherein the hood is comprised of at least one side wall, said at least one side wall including at least one waveguide formed therein.

29. The apparatus of claim 28, wherein the at least one waveguide is formed from first and second translucent layers which are coupled to one another and separated by an air gap.
